(19) United States
(12) Patent Application Publication
(10) Pub. No.: US 2002/0021985 A1
(43) Pub. Date: Feb. 21, 2002

(54) Electrostatically charged aerosol decontamination system and method

(76) Inventors: Carl R. Peterson, Boxford, MA (US); John F. McCoy III, North Chelmsford, MA (US); Richard A. Covel, Stow, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 09/885,145

(22) Filed: Jun. 20, 2001

Related U.S. Application Data
(60) Provisional application No. 60/212,760, filed on Jun. 20, 2000.

(51) Int. Cl. B32B 27/12

(52) U.S. Cl. 422/88

(57) ABSTRACT

An electrostatically charged aerosol decontamination system and method includes generating an aerosol fog of a decontamination reagent; electrostatically charging the aerosol particles; and dispensing the electrostatically charged aerosol particles in a contaminated area to neutralize the contaminating agent.

### RELATED APPLICATIONS

This application is based on U.S. Provisional Patent Application No. 60/212,760 filed on Jun. 20, 2000.

### FIELD OF THE INVENTION

This invention relates to an electrostatically charged aerosol decontamination system and method.

### BACKGROUND OF THE INVENTION

Traditional decontamination delivery systems (aerosols, aerators, liquids sprays, and foggers) and reagents (powders, sprays, and foams) are adequate for some applications. However, they do not offer the most complete or flexible decontamination solutions. Difficulties are greatly amplified when attempting to decontaminate rooms and equipment contaminated with toxic materials such as nerve agents. Personnel conducting the decontamination are attired in special (DPE) suits (thick plastic chemical protection suits) that severely limit their visibility, range of motion, and time to act before they must leave the contaminated area. Decontamination is a labor-intensive, sometimes dangerous, process carried out by specially trained personnel. This can be a repetitive process that is carried out until the desired level of cleanliness is achieved. In addition to the actual working crew, additional support staff is required to monitor and support all personnel conducting operations in DPE suits. Experience has demonstrated that a single treatment using current practices is ineffective at providing complete decontamination. The typical procedure includes several cycles of reagent application and air quality inspection, followed by additional reagent application until the contaminated surfaces no longer emit agent during air quality testing. Certain factors increase difficulty, such as irregular surfaces, variation in materials and component complexity (i.e., typical machinery and equipment). With agent and agent vapor having penetrated surface materials, cracks, and crevices (in all possible orientations), it is unlikely that the decontamination fluid will remain on surfaces in sufficient quantity and for sufficient time to complete the process. Decontamination solutions need to be continually refreshed to achieve complete decontamination. The typical use of caustic, corrosion causing reagents coupled with large amounts of water results in high risk of material and equipment damage. This can also create challenges relative to disposal considerations.

### SUMMARY OF THE INVENTION

It is therefore an object of this invention to provide an improved electrostatically charged aerosol decontamination system and method.

It is a further object of this invention to provide such an improved electrostatically charged aerosol decontamination system and method which provides a more effective distribution of the decontaminating reagent and uses less of the reagent.

It is a further object of this invention to provide such an improved electrostatically charged aerosol decontamination system and method which provides better coverage of complex surfaces, cracks and crevices.

It is a further object of this invention to provide such an improved electrostatically charged aerosol decontamination system and method which provides continuous presence and replenishment of reagent allowing capillary action and absorption so that even trapped contamination agents are “removed or destroyed”.

It is a further object of this invention to provide such an improved electrostatically charged aerosol decontamination system and method which provides much more controlled application of the decontamination reagent.

It is a further object of this invention to provide such an improved electrostatically charged aerosol decontamination system and method which can be accomplished without employing personnel to dispense the reagent in a contaminated area.

It is a further object of this invention to provide such an improved electrostatically charged aerosol decontamination system and method which is effective to treat airborne contamination agents as well as those on and beneath surfaces.

It is a further object of this invention to provide such an improved electrostatically charged aerosol decontamination system and method which is equally applicable to many decontamination applications, e.g. personnel, equipment, rooms, holding tanks, vehicles.

It is a further object of this invention to provide such an improved electrostatically charged aerosol decontamination system and method which maintains engagement of the decontamination reagent to insure sufficient time for effective treatment.

The invention results from the realization that a truly effective decontamination method and system for airborne and surface borne contamination agents which uses a minimum volume of the decontamination reagent with maximum effect, services cracks, crevices and all sorts of complex surfaces and allows time for absorption and capillary action can be achieved by providing an aerosol from a decontamination reagent fluid or powder, electrostatically charging the aerosol particles and dispersing those charged particles in the area to be decontaminated.

This invention features an electrostatically charged aerosol decontamination system including a source of decontamination reagent and an aerosol device for converting the decontamination reagent into an aerosol fog. An electrostatic charging circuit induces an electrostatic charge on the aerosol particles for attracting them to the medium to be neutralized. The agent may be disbursed in air or may be on or in the surface of objects.

In a preferred embodiment the aerosol device may include a nozzle. There may be a source of pressurized fluid and a nozzle may be connected to the source of pressurized fluid and the source of decontamination reagent. The aerosol device may also include a pressurizing device for pressurizing the decontamination reagent for delivery to the nozzle. The aerosol device may include a rotating disk and a delivery device for delivering a flow of decontamination reagent to the rotating disk. The decontamination reagent may be a fluid or a powder. The medium may be a contaminating agent or a contaminated body.

This invention also features a method of electrostatically charged aerosol decontamination including generating an aerosol fog of a decontamination reagent, and electrostatically charging the aerosol particles. The electrostatically charged aerosol particles are dispensed in a contaminated area to neutralize the contaminating agent.

### BRIEF DESCRIPTION OF THE DRAWINGS

Other objects, features and advantages will occur to those skilled in the art from the following description of a preferred embodiment and the accompanying drawings, in which:

FIG. 1 is a schematic elevational sectional view of an electrostatically charged aerosol decontamination system according to this invention;

FIGS. 2A-D are schematic diagrams of electrostatic charging circuits which may be used in accordance with this invention;

FIG. 3 is a schematic diagram of a rotating disk type of aerosol device which may be used in accordance with this invention;

FIG. 4 is a schematic three-dimensional view of a number of electrostatically charged aerosol decontamination systems employed in a decontamination of field equipment;

FIG. 5 is a schematic three-dimensional view of another application of the electrostatically charged aerosol decontamination system according to this invention in a chemical weapons disassembly and disposal facility;

FIG. 6 is a schematic three-dimensional view of another application of the electrostatically charged aerosol decontamination system according to this invention for holding tank interior decontamination according to this invention;

FIG. 7 is schematic three-dimensional view of another application of the electrostatically charged aerosol decontamination system according to this invention for building interior decontamination according to this invention;

FIG. 8 is a schematic three-dimensional view of another application of the electrostatically charged aerosol decontamination system according to this invention for personnel decontamination according to this invention; and

FIG. 9 is an illustrative schematic of the interacting electrostatic fields of the reagent, agent and body.

### PREFERRED EMBODIMENT

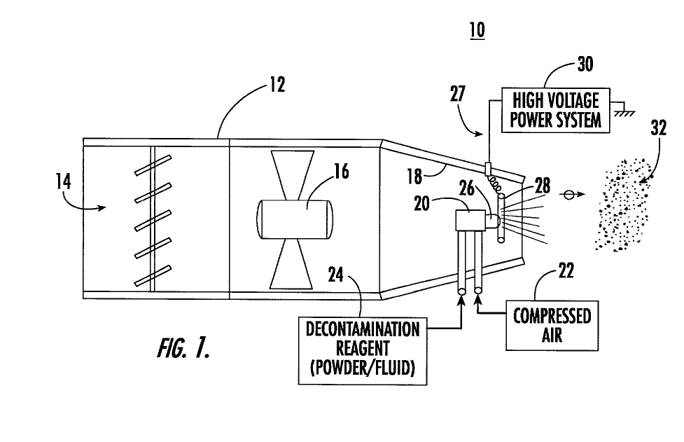

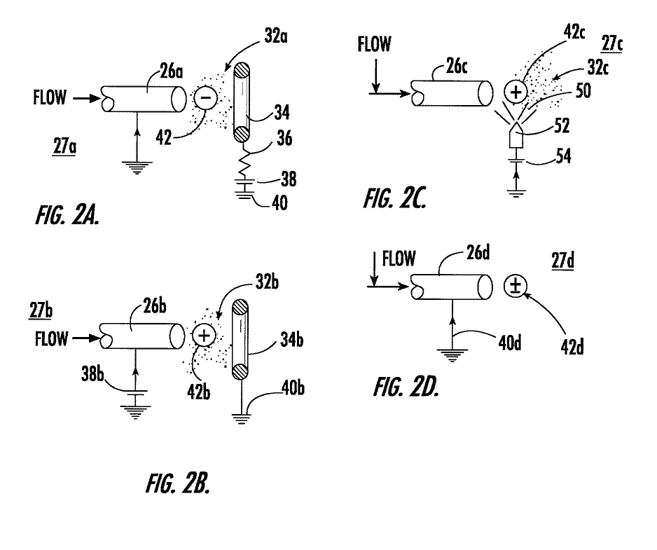

There is shown in FIG. 1 an electrostatically charged aerosol decontamination system 10 according to this invention including a ducted blower or nozzle 12 having dampers 14 which control the flow of air to fan 16 that provides the air to the tip flow cone 18 of nozzle 12. A spray nozzle 20 receives one input from a compressed air source 22 and one from the decontamination reagent source 24 which may be in the form of powder or fluid. As it exits from nozzle 26 the aerosol droplets or particles move through an electrostatic field created by electrostatic charge circuit 27 including induction ring 28 energized by high voltage power supply 30 thereby creating an aerosol fog whose droplets or particles 32 are electrostatically charged. Such devices are known in the field. The particular type of aerosol device that creates the aerosol fog and the particular electrostatic charging circuit are not a specific part of this invention as any suitable device may be used. For example the electrostatic charge circuit 27a, FIG. 2A, is shown as an induction ring 34 connected through a resistor 36 and high voltage source 38 to ground 40. Induction ring 34 is disposed just off the end of nozzle 26a to create the charged condition of the particles as shown at 42.

Alternatively, induction ring 34b, FIG. 2B, may be directly grounded as at 40b, in which case the aerosol fog 32b will have the positive charge 42b as it exits nozzle 26b in contrast to the negative charge 42 shown in FIG. 2A. In FIG. 2B the high voltage source 38b is interconnected between nozzle 26b and ground. Alternatively to the induction charging circuits of FIGS. 2A and 2B the electrostatic charging circuit 27c may be an ion bombardment type 26c, FIG. 2C, wherein the nozzle 26c wherein the particles of the aerosol fog 32c are charged positively for example as shown at 42c by the corona discharge 50 from a corona point 52 powered by a high voltage source 54. Circuit 27d, FIG. 2D, may also be implemented as a spray electrification type wherein the nozzle 26d is grounded as at 40d.

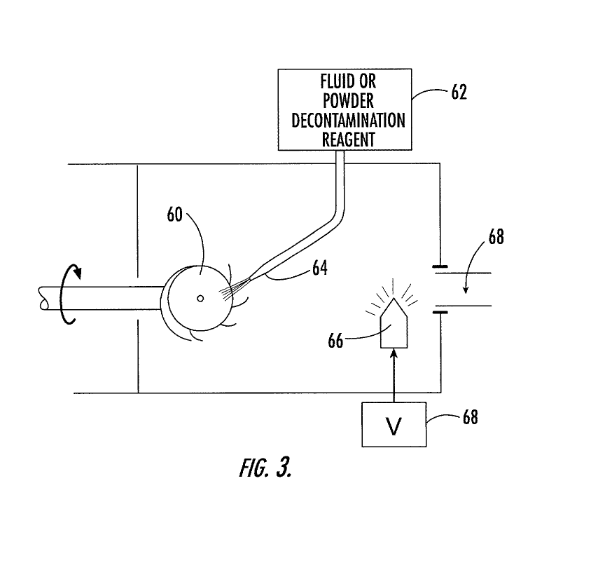

In addition to the use of nozzles for the aerosol production any other suitable technique can be used. For example as shown in FIG. 3, a rotating disk 60 may be confronted with a fluid or powder decontamination reagent from source 62 through distributor 64. The centrifugal force of rotating disk 60 breaks up the reagent into droplets or particles in an aerosol fog which can then be electrostatically charged for example by corona point 66 powered by high voltage supply 68 after which the decontaminant reagent can be driven out of port 68 into the contaminated area using fans or similar devices.

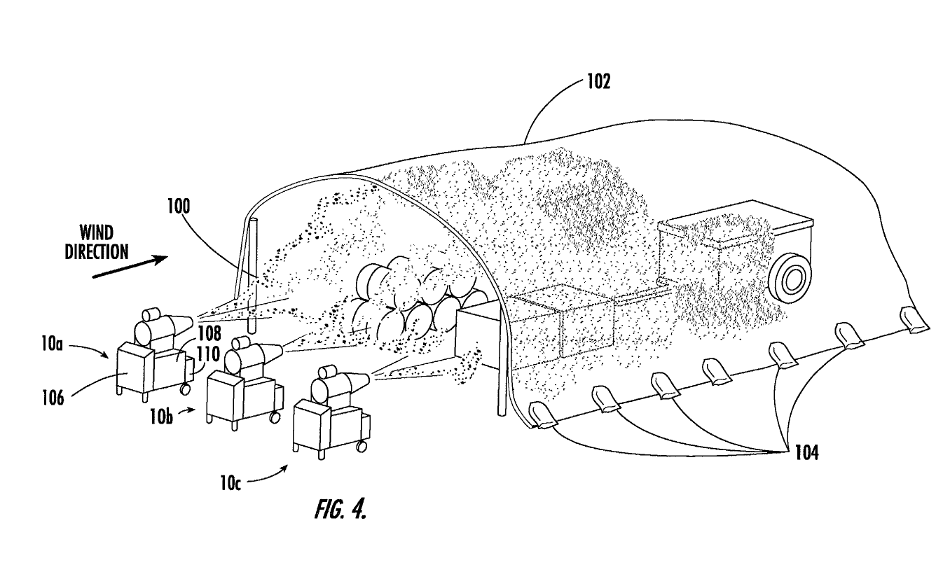

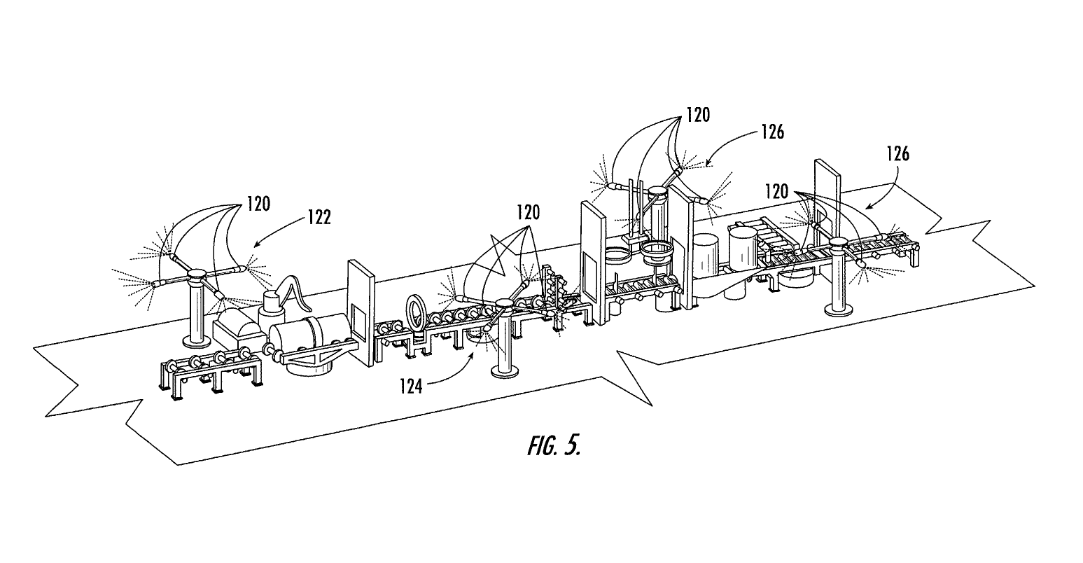

The electrostatically charged aerosol decontamination system 10 may be used in a number of applications for example as shown in FIG. 4 three such devices, 10a, 10b and 10c are shown providing the decontamination reagent in electrostatically charged aerosol form 100 into a temporary building made from a flexible plastic covering 102 and held down by sandbag weights 104. The medium to be decontaminated may be the contaminating agent or body or both. The building may contain any manner of vehicles and equipment. As shown each of the systems 10a, 10b and 10c may contain its own source of decontamination reagent 106 air compressor 108 and voltage supply 110 as shown specifically only with respect to system 10a. Alternatively, the generation of the aerosol and the electrostatic charging of the particles may be done remote from the site and the charged aerosol simply supplied to a suitable nozzle arrangement such as shown in FIG. 5 where there are four distribution nozzles 120 at each of four different stations 122, 124, 126, and 128 for use in a chemical weapons disassembly and disposal facility for decontamination.

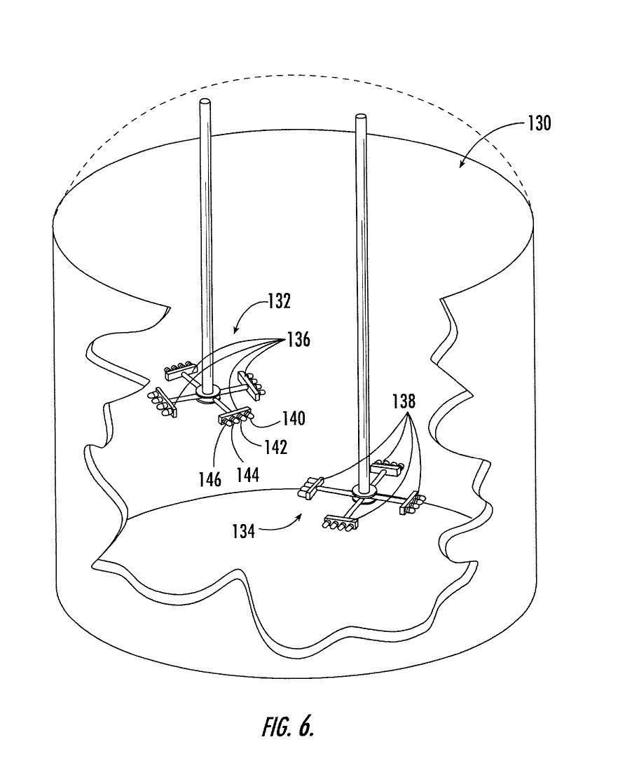

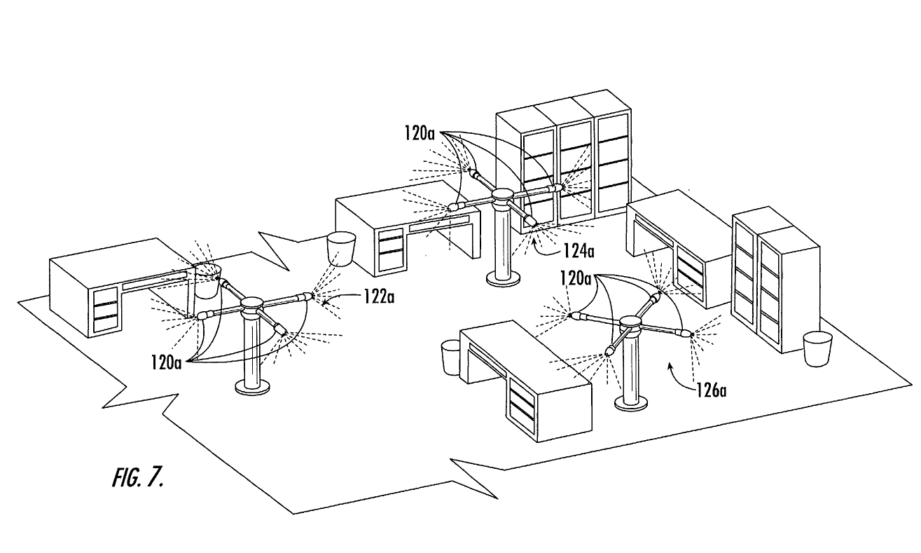

The effective distribution of the electrostatically charged aerosol with use of minimum volume of the decontamination reagent is depicted graphically in FIG. 6 where a holding tank 130 can have its entire interior decontaminated using but two heads 132, 134 each with four nozzle arrays 136, 138 each of which array has four individual nozzles 140, 142, 144, and 146 in this way a holding tank which would ordinarily have to be filled to its full capacity or at least heavily hosed down with a great volume of decontamination reagent will only require a minimum amount of the decontamination reagent as it electrostatically clings to the inner surfaces and penetrates the crevices. The distribution systems similar to those shown in FIG. 5 may also be used to decontaminate building interiors as shown in FIG. 7 where stations 122a, 124a, and 126a are shown being used to decontaminate a room including all its furniture and contents.

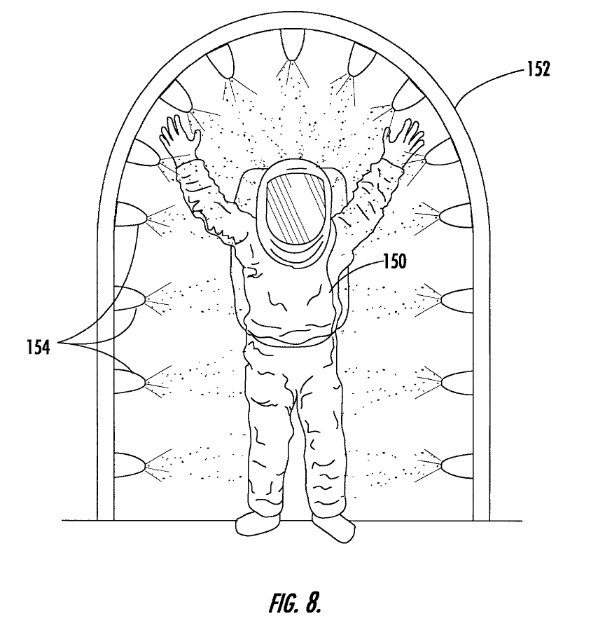

In addition to inanimate objects the electrostatically charged aerosol decontamination system according to this invention can also be used to decontaminate personnel still in their protective suits 150, FIG. 8, by simply having them step into a room or chamber 152 which is fitted with a plurality of nozzles 154 that discharge the electrostatically charged decontamination reagent which will cling to the suit and penetrate the many folds and creases.

Typical decontaminant reagents and the contaminating agents that they neutralize include: sodium hypochlorite solution, caustic or any type of reagent that is in solution. Liquids such as sodium hypochlorite can be made into an aerosol using pressure atomizing nozzles at 60-70 psi pressure with range of orifice sizes. Powders of 5-50 micron size can be made into aerosol at 60-90 psi with nozzles with a range of orifice sizes.

The action of the charged decontamination reagent is illustrated schematically in FIG. 9 where the decontamination reagent particles 160 are shown charged positively (+). The like positive charges on particles 160 tend to drive them apart and distribute them until they are attracted to the negative (−) contamination agent vapor, particles 162, proximate body 164 which is also negatively charged. There may also be agent in liquid form 162′ on body 164 and in its cracks 166 and hollows 168 and along its surface 170 generally. It is the attraction between the positively charged reagent and the negatively charged agent and/or body that effects the improved decontamination according to this invention. The action occurs so long as the reagent is sufficiently positively charged relative to the agent/body. In one application a positive charge of 1200-1500 volts d.c. on the reagent with the agent/body at ground effected good results. The medium to be decontaminated may be the agent, the body or both including toxic, poisonous, lethal or otherwise hazardous materials.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. An electrostatically charged aerosol decontamination system comprising:
a source of decontamination reagent;
an aerosol device for converting said decontamination reagent into an aerosol fog; and
an electrostatic charging circuit for inducing an electrostatic charge on the aerosol particles for attracting them to the medium to be neutralized.

2. The electrostatically charged aerosol decontamination system of claim 1 in which said aerosol device includes a nozzle.

3. The electrostatically charged aerosol decontamination system of claim 2 in which said aerosol device includes a source of pressurized fluid and said nozzle is connected to said source of pressurized fluid and said source of decontamination reagent.

4. The electrostatically charged aerosol decontamination system of claim 2 in which said aerosol device includes a pressurizing device for pressurizing the decontamination reagent for delivery to said nozzle.

5. The electrostatically charged aerosol decontamination system of claim 1 in which said aerosol device includes a rotating disc and a delivery device for delivering a flow of decontamination reagent to said rotating disc.

6. The electrostatically charged aerosol decontamination system of claim 1 in which said decontamination reagent is a fluid.

7. The electrostatically charged aerosol decontamination system of claim 1 in which said decontamination reagent is a powder.

8. The electrostatically charged aerosol decontamination system of claim 1 in which said medium is a contaminating agent.

9. The electrostatically charged aerosol decontamination system of claim 1 in which said medium is a contaminated body.

10. A method of electrostatically charged aerosol decontamination comprising:
generating an aerosol fog of a decontamination reagent;
electrostatically charging the aerosol particles; and
dispensing the electrostatically charged aerosol particles in a contaminated area to neutralize the contaminating agent.
